(19) United States
(12) Patent Application Publication
(10) Pub. No.: US 2014/0118111 A1
(43) Pub. Date: May 1, 2014

(54) DETERMINING THE STATE OF A GARAGE DOOR USING VEHICLE SENSORS

(71) Applicant: CONTINENTAL AUTOMOTIVE SYSTEMS, INC., Auburn Hills, CA (US)

(72) Inventors: Peter Saladin, Palatine, IL (US); Michael Daleki, Addison, IL (US); Thomas Brey, Lake In The Hills, IL (US)

(73) Assignee: CONTINENTAL AUTOMOTIVE SYSTEMS, INC., Auburn Hills, MI (US)

(21) Appl. No.: 13/663,628

(22) Filed: Oct. 30, 2012

(51) Int. Cl. G08B 5/22; G06K 7/01

(52) U.S. Cl. 340/7.51

(57) ABSTRACT

A garage door can be detected as being open by sensing various physical conditions the existence of which indicate the garage door as being open. When a door is determined to be open, a notification message is wirelessly transmitted to a predetermined entity or person notifying them that the door is open. Corrective action can then be taken to close the door to keep the vehicle and contents of the garage secure.

### BACKGROUND

Most vehicle owners prefer to keep their vehicles in a secured garage, i.e., a garage equipped with an overhead garage door through which the vehicle can be moved into and out of the garage. Most people also prefer such garage doors to be operated by a wirelessly controlled garage door opener.

A relatively common problem with garage doors is that they are sometimes left open inadvertently. Garage doors are often left open because a vehicle operator forgot to close the door or because an obstruction is in the door's path, which inhibits most garage door openers from operating. A garage door detector that is able to determine whether a garage door is open or closed would be an improvement over the prior art. A detector that is also able to communicate the state of the garage door would also enable an owner of the garage or an owner/operator of the vehicle to decide wither corrective action should be taken.

### BRIEF SUMMARY

In accordance with embodiments of the invention, a garage door can be detected as being open by sensing various physical conditions the existence of which indicate the garage door as being open. When a door is determined to be open, a notification message may be wirelessly transmitted to a predetermined entity or person notifying them that the door is open. Corrective action may then be taken to close the door to keep the vehicle and contents of the garage secure.

### BRIEF DESCRIPTION OF THE DRAWINGS

FIG. 1 depicts a first embodiment of garage door position detector;

FIG. 2 is a block diagram of a processor for use with various different embodiments of door detectors;

FIG. 3A and 3B depict a method for determining whether a garage door 108 is open or closed using a detector such as the one depicted in FIG. 1;

FIG. 4 depicts a second embodiment of garage door position detector;

FIG. 5 depicts a third embodiment of garage door position detector;

FIG. 6 depicts a fourth embodiment of garage door position detector; and

FIG. 7 depicts a fifth embodiment of garage door position detector.

### DETAILED DESCRIPTION

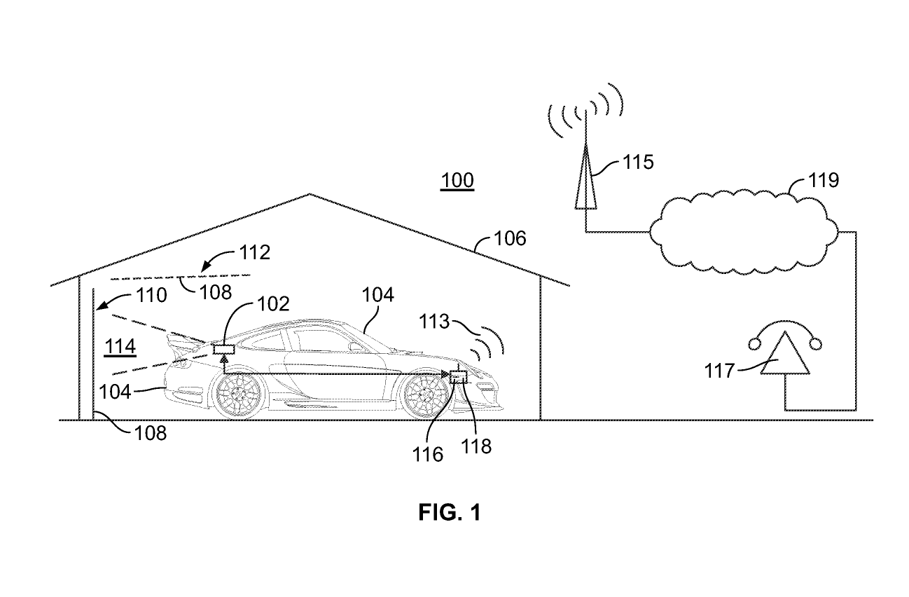

FIG. 1 depicts a first embodiment of garage door position detector 100. It also depicts a vehicle 104 that is provided with one or more types of sensors described below.

The detector 100 shown in FIG. 1 is configured to repeatedly determine the location or status of a garage door, i.e., determine whether a garage door is open, by comparing a image of what is behind the vehicle 104 to previously-captured images of the garage door 108 being open and closed. Importantly, the detector 100 is able to determine the status of any garage door for any garage.

If the garage door 108 is determined to be open, the detector 100 wirelessly transmits an open door notification message. The message can be sent to a predetermined person or entity, such as the vehicle's owner, the garage's owner or some other person or entity, notifying one or more of them that the door is open. Corrective action can then be taken to close the door and secure the vehicle and contents of the garage.

The notification message can be embodied as a text message, i.e., a data message or e-mail, or a pre-recorded audio message. The destination or address of the text message or e-mail can be specified in advance, i.e., be predetermined.

The detector 100 depicted in FIG. 1 comprises a camera 102 attached to a motor vehicle 104. The vehicle 104 is depicted in FIG. 1 as being parked inside a garage 106 with a conventional, vertically-operated sectional door 108, which is shown in its “down” or closed position 110. The vehicle 104 can be driven into and out of the garage 106 when the door 108 is in its “up” or open position 112. The door 108 is preferably operated by a conventional, remotely controlled garage door opener mechanism, not shown, but well known to those of ordinary skill in the art.

The camera 102 is preferably mounted inside the vehicle 104 but nevertheless positioned to be able to capture images in a field of view 114 outside and behind the vehicle 104. Images are captured as frames, as is well known. Each frame comprises multiple individual picture elements or pixels, as is also well known.

In FIG. 1, the camera 102 is directed rearward in order to “see” and capture images of what is behind the vehicle 104. The camera 102 could also be directed toward the front of the vehicle 104 to capture images in a field of view that is also in front of the vehicle 104.

The camera 102 is coupled to and controlled by a processor 116. The processor 116 is also coupled to, and preferably co-located with a wireless transceiver 118. The transceiver 118 can be embodied as either an audio signal transducer such as a speaker or a light source but in a preferred embodiment, the transceiver 118 is preferably a radio frequency transceiver provided with a dual-band transmission capability. It is able to transmit and receive on one or more cellular bands as well as transmit garage door opener control signals on one or of the radio frequency bands commonly used by remote garage door openers. It is able transmit signals 113 to a conventional cellular network 115 and thereby communicate to other devices such as a conventional telephone 117 by way of data and switching networks 119 to which such other devices can be directly or indirectly coupled.

As stated above and as is well known, the camera 102 captures images in its field of view 114 as frames. As also well known, each frame comprises multiple individual picture elements or pixels. The number of pixels in a captured frame determines the camera's resolution and is a design choice but those of ordinary skill in the art will recognize that image/frame quality will be directly related to the number of pixels in the image/frame.

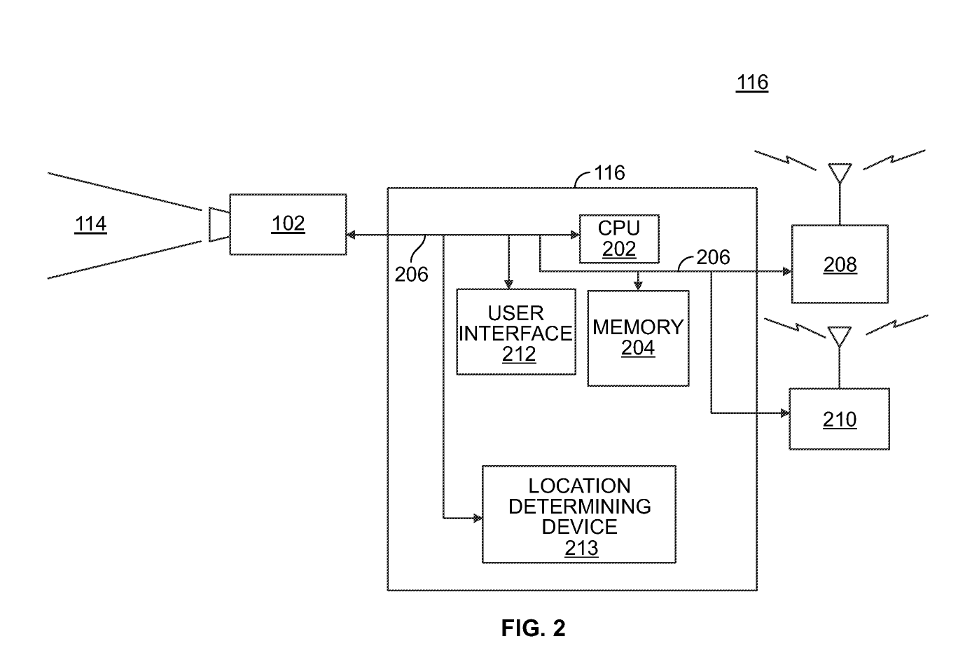

FIG. 2 is a block diagram of the processor 116 used with the various door detectors disclosed herein. A central processing unit (CPU) 202 is coupled to a conventional, non-volatile, non-transitory memory device 204, via a conventional bus 206. The bus 206 is a set of parallel electrical conductors that form a main transmission path. It carries address, control and data to and from the CPU 202.

The memory device 204 stores data and program instructions. When they are executed by the CPU 202, they cause the CPU to exercise control over the camera 102 and other devices coupled to the bus 206.

In addition to coupling the CPU 202 to the memory device 204, the bus 206 also couples the CPU 202 to the camera 102, a conventional cellular telephone transceiver 208 and a conventional wireless garage door transmitter 210. Other sensors described below are coupled to the CPU 202 in the same way that the camera 102 is coupled to the CPU 202.

A location determining device or “location determiner” 213 is also coupled to the CPU 202 via the bus 206. The location determining device is used to determine where the vehicle is located, prior to determining whether a garage door is up or down. The location determining device 213 is preferably embodied as a global positioning system receiver. One alternate embodiment of the location determining device 213 includes a cellular telephone radio configured to locate the vehicle by triangulation using signals from nearby towers. Another alternate embodiment is a “WI-FI” receiver and database from which the location of the vehicle can be determined if the SSID of a received WI-FI signal corresponds to a WI-FI signal that is received when the vehicle is in the garage.

The cellular telephone transceiver 208, garage door transmitter 210, CPU 202, memory device 204 are preferably co-located, i.e., within the same housing and/or on the same circuit board, not shown but well known to those of ordinary skill in the art.

A user interface 212 is also coupled to the CPU via the bus 205. It is preferably embodied as a conventional touch-sensitive display panel. It allows input commands to be input to the CPU 202 from a user.

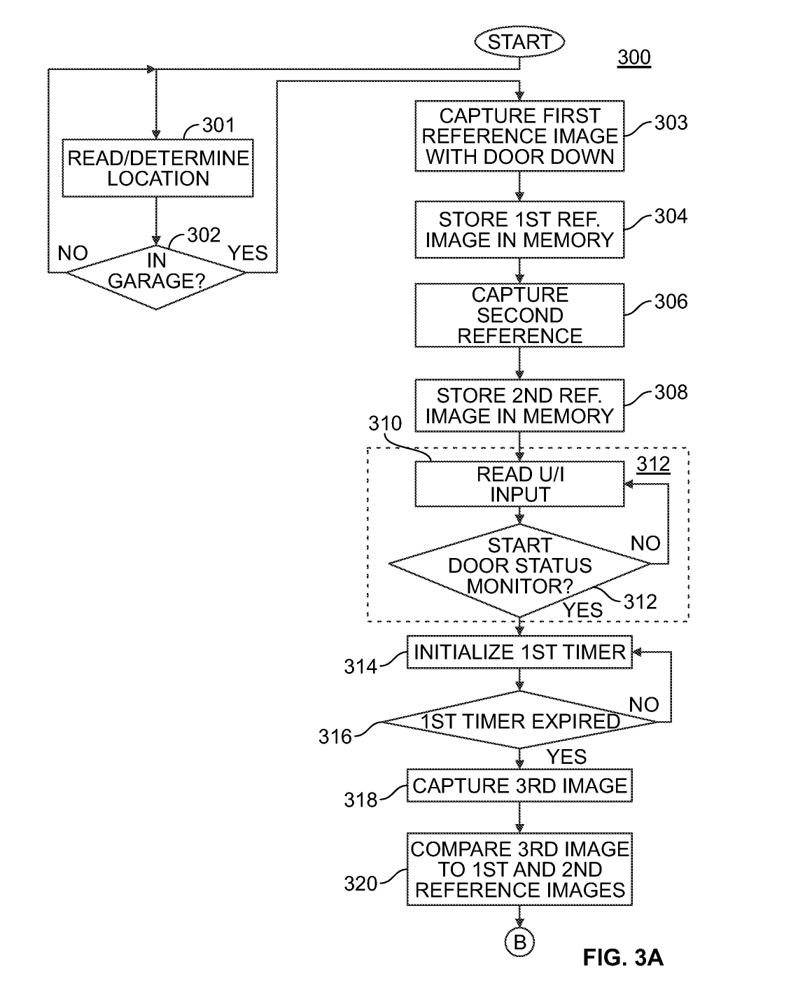

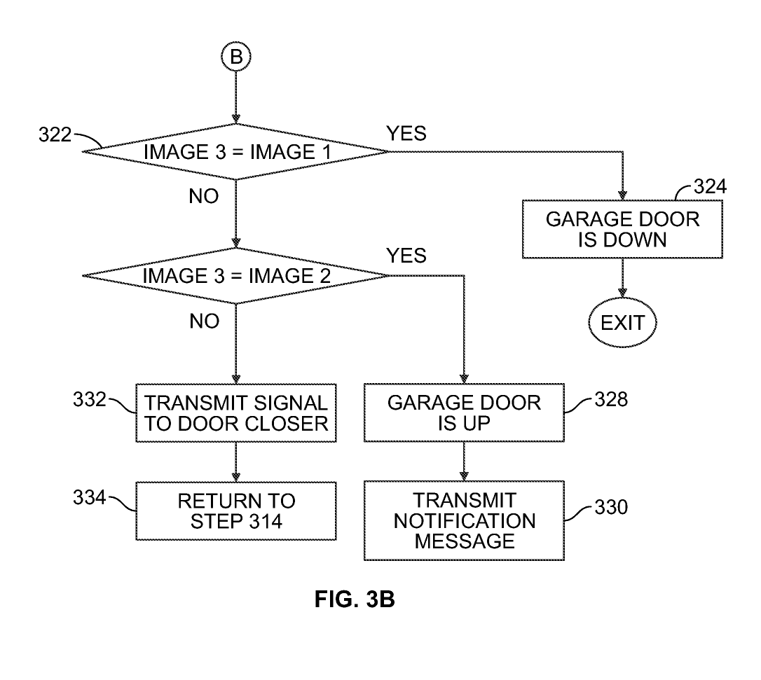

FIG. 3A and 3B a method 300 for determining whether the garage door 108 is “up” or open 112 using the detector depicted in FIG. 1. In a first step 301, the location of the vehicle is read from a location-determining device such as a global position system, a dead-reckoning navigation system or from a radio receiver that “hears” signals from either a cellular telephone network or a “WI-FI” system. At step 302, the location determined from step 301 is compared against a location where the vehicle would be if it is in a garage. If the results of the test at step 302 are positive, i.e., the vehicle is actually in a garage, the method proceeds to t step 303, which takes place while the vehicle 104 is located inside of the garage 106.

In step 303, the processor 116 instructs or controls the camera 102 to capture a first reference image, i.e., capture the field of view 114, when the garage door 108 is deliberately or intentionally located at its down position 110. At step 304, the first reference image is stored in the memory device 204 as a first reference frame.

At step 306, which takes place after the first reference frame is captured and stored, and after the garage door 108 is moved to its up position 112, the processor 116 instructs or controls the camera 102 to capture a second reference frame, which is an image of the field of view 114 when the garage door 110 is in its up position 112. The second reference image of the field of view 114 is stored in the memory device 204 as a second reference frame.

After the first and second reference frames are stored in the memory device 204, the processor 116 can autonomously determine whether the garage door 108 is up 112 or down by the processor 116 instructing the camera 102 to capture a third image of the field of view 114. Determining whether the garage door 108 is up 112 or down 110 can be made by pattern recognition, i.e., determining the presence or absence of one or more shapes in the third image. The door 108 can also be determined to be up 112 or down 110 by comparing pixels of the third captured image of the field of view 108 to corresponding pixels of one or both of the first and second reference frames.

At step 310, a loop 312 is entered during which the method 300 waits for a command from the user interface 212 to start monitoring the garage door. When a command to monitor the garage door is received, a first timer is initialized at set 314. The length of the first timer 314 is chosen to allow passengers of the vehicle to exit the vehicle and the garage before the garage door monitoring is begun. Garage door monitoring starts at the expiration of the timer as part of step 316.

At step 318, a third image is captured by the camera. At step 320 the third image is compared to the first two images successively.

The third image is compared to the first captured image at step 322. If the two images are the same or substantially the same, the garage door 108 is determined at step 324 to be down. The method 300 is thereafter terminated.

If the third captured image is not the same as the first captured image, a second text is performed at step 326 whereat the third image is compared to the second captured image. If the third image is the same or substantially the same as the second captured image, the door 108 is considered to be open at step 328. A door open notification message is transmitted at step 330.

If for some reason the third captured image is not at least substantially the same as the second captured images, the method 300 transmits a door close signal to the garage door closer at step 332. After the door closer is operated, the method returns to step 314 where the first timer is re-initialized and counted down before another image of the field of view is captured. Eventually the garage door 108 is detected to be up and a message is sent or the door is determined to be down.

In the first, preferred embodiment which uses a camera to detect a garage door, the garage door 110 is determined to be up 112 if the third image more closely or “substantially” matches the second reference image than it does the first reference image. In other words, the determination of whether the garage door 108 is up 112 or down 110 is made simply by determining which of the two reference images most closely conforms to or matches a third captured image.

Captured images are determined to be either substantially matched or substantially unmatched, i.e., similar or dissimilar, by comparing the two images or image frames on a pixel-by-pixel basis. Images can also be determined to be matched or similar by comparing groups or clusters of adjacent pixels in two different image frames. Images captured by the camera 102 are thus considered herein to be signals that are used to indicate whether the door 108 is up 112 or down 110. When the door 108 is determined to be up 112 using the captured images, the processor 116 directs the wireless transmitter to transmit a message to either the vehicle owner, garage owner or some other person or entity, notifying them of the door's open status. Theft or loss protection measures can thereafter be taken. If the door 108 is not closed within a predetermined length of time, the detector is able to close the garage door 108 itself by transmitting an opener-actuating signal to the remotely-controlled garage door opener. The garage door opener is not shown. Such devices are well known,

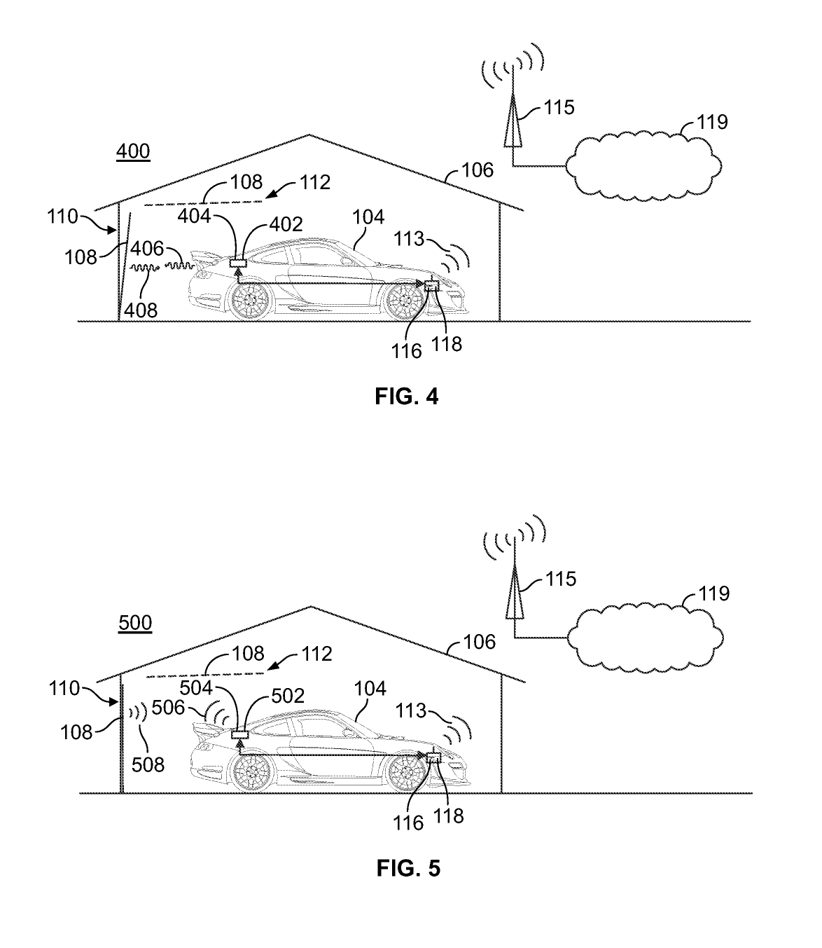

FIG. 4 depicts a second embodiment of garage door position detector 400. As with the first embodiment, the detector 400 shown in FIG. 4 is configured to repeatedly and/or continuously determine the location or status of a garage door 108, i.e., determine whether a garage door 108 is in its “up” or open 112 position. As with the first embodiment, the second embodiment is able to determine the status of any garage door for any garage.

If the door 108 is determined to be open 112, the garage door position detector 400 wirelessly transmits an open door notification message 113 to a predetermined person or entity, such as the vehicle's owner, the garage's owner or some other person or entity, notifying one or more of them that the door is open. The notification message 113 can be embodied as a text message, i.e., a data message or e-mail, or a pre-recorded audio message. The destination or address of the text message or e-mail can be specified in advance, i.e., the destination to which the message is sent can be predetermined. If the door 108 is not timely closed, i.e., closed within a predetermined number of minutes or hours after the notification message is sent, the detector 400 can close the garage door 108 itself by transmitting a door close signal to the door's opener.

In FIG. 4, the detector 400 comprises a laser 402 and a co-located light detector 404 attached to the motor vehicle 104. They are configured to measure distance between the laser and a surface or object such as a garage door 108 behind the vehicle by measuring the time between a light pulse's transmission and its reception.

Short-duration light pulses 406 are transmitted from the laser 402. In FIG. 4, the light pulses 406 are transmitted in a direction that is behind the vehicle. If a garage door 108 behind the vehicle is down or closed 110, transmitted pulses of light 406 will be reflected by the door 108 to form reflected light pulses 408 and thus detectable by the light detector 404 co-located with the laser 402, i.e., adjacent to the laser 402. When reflected light pulses 408 are detected by the detector 404, the door 108 is considered to be down or closed 110. The presence or absence of reflected light pulses 408 can thus be used to determine whether the door 108 is up 112 or down 110.

Light pulses that are detected impinge on a conventional photodiode, not shown, the output of which is a measurable electrical voltage comprising an output of the detector 404. Such an output, or lack thereof is generated responsive to the detection of reflected light pulses 408. Such an output, or lack thereof is therefore considered to be representative of the garage door being open or closed.

The method of determining whether a garage door is open shown in FIG. 3 can be easily modified to be used with the apparatus shown in FIG. 4. Instead of comparing images, as is required when the garage door location sensor is a camera, the method of FIG. 3 is modified to calculate or determine the distance between the laser and an object or surface that reflects the transmitted light pulses 406. It is well known that distance, D, is equal to rate (R) multiplied by time, (t). Since the speed of light is well known, the distance between the vehicle and the garage door can thus be calculated by measuring the time between transmission and reception of a light pulse. If the measured distance between the laser 402 and a light reflecting surface exceeds a predetermined maximum, the garage door 108 can be assumed to be open. A door open notification message can be sent. If such a message does not result in the garage door 108 being closed before the expiration of a maximum time, a door close signal can be transmitted to a garage door opener.

FIG. 5 depicts a third embodiment of garage door position detector 500. As with the first embodiment, the detector 500 shown in FIG. 5 is configured to repeatedly and/or continuously determine the location or status of a garage door 108, i.e., determine whether a garage door 108 is in its “up” or open 112 position, by measuring distance between the vehicle and where the garage door should be located when it is down. Distance is measured ultrasonic ally. If the door 108 is determined to be open 112, the garage door position detector 400 wirelessly transmits an open door notification message to a predetermined entity, such as the vehicle's owner, the garage's owner or some other person or entity, notifying one or more of them that the door is open. As with the first two embodiments, the notification message 113 can be embodied as a text message, i.e., a data message or e-mail, or a pre-recorded audio message. The destination or address of the text message or e-mail can be specified in advance, i.e., be predetermined. If the door 108 is not timely closed, i.e., closed within a predetermined number of minutes or hours after the notification message is sent, the detector 400 can close the garage door 108 itself.

In FIG. 5, the detector 500 comprises an ultrasonic transmitter 502 and a co-located ultrasonic receiver 504 attached to the motor vehicle 104. Similar to the second embodiment, which measures distance using light pulses, the ultrasonic transducers 502 and 504 measure distance between themselves and a surface or object such as a garage door 108 using transmitted ultrasonic sound waves 510 and reflected ultrasonic sound waves 512.

Short duration ultrasonic sound pulses 510 are transmitted from the ultrasonic transmitter 502. If a garage 108 door 108 is down or closed 110, transmitted pulses of ultrasonic sound 510 will be reflected by the door 108 to form reflected sound waves 512. The reflected sound waves 512 are detectable by the ultrasonic receiver 504, which is co-located with the ultrasonic transmitter 502. When reflected sound waves 512 are detected by the ultrasonic receiver 504, the door 108 is considered to be down or closed 110. The presence or absence of reflected sound waves or pulses 512 can thus be used to determine whether the door 108 is up 112 or down 110. A signal that is output of the ultrasonic receiver 504, which is output responsive to the detection of reflected sound waves 512, or a lack thereof, is considered herein to be representative of the garage door being open or closed.

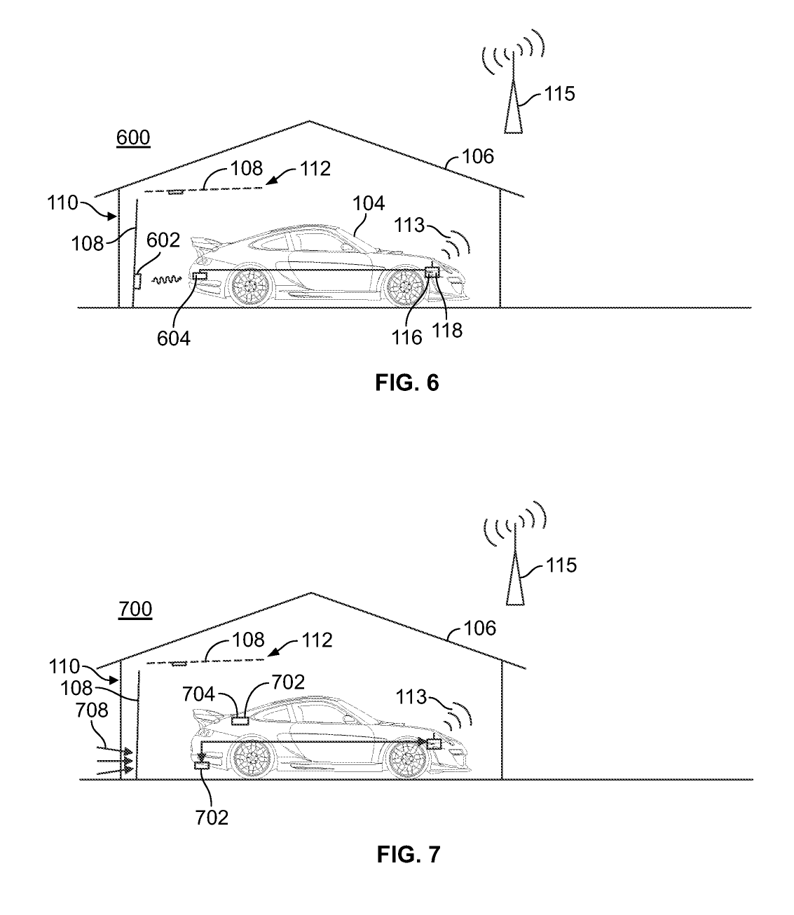

FIG. 6 depicts a fourth embodiment of garage door position detector 600. As with the first three embodiments described above, the detector 600 shown in FIG. 6 is configured to repeatedly and/or continuously determine the location or status of a garage door 108, i.e., determine whether a garage door 108 is in its “up” or open 112 position, by the presence or absence of an RFID tag affixed to the garage door. If the door 108 is determined to be open 112, the garage door position detector 600 wirelessly transmits an open door notification message to a predetermined entity, such as the vehicle's owner, the garage's owner or some other person or entity, notifying one or more of them that the door is open. As with the first two embodiments, the notification message 113 can be embodied as a text message, i.e., a data message or e-mail, or a pre-recorded audio message. The destination or address of the text message or e-mail can be specified in advance, i.e., be predetermined. If the door 108 is not timely closed, i.e., closed within a predetermined number of minutes or hours after the notification message is sent, the detector 600 can close the garage door 108 itself.

In FIG. 6, the detector 600 comprises a radio frequency identification (RFID) tag 602 attached to the garage door and a RFID detector 604 attached to the motor vehicle 104 at a location where the detector 604 is able to sense the tag 602 when the 108 is in its down position 110. The controller 116 periodically sends a signal to the detector 604 that instructs the detector 604 to interrogate its surroundings for the presence of a particular RFID tag 602 attached to the door 108. If such an RFID tag 602 is sensed, the detector 604 responds to the controller's query by way of a signal indicating that the tag 602 was detected. The output signal from the detector 604, not shown but well known to those of ordinary skill in the art, thus comprises a signal that is indicative of, and responsive to, the door 108 being up 112 or down 110.

Finally, FIG. 7 depicts a fifth embodiment of garage door position detector 700. As with the first three embodiments described above, the detector 700 shown in FIG. 7 is configured to repeatedly and/or continuously determine the location or status of a garage door 108, i.e., determine whether a garage door 108 is in its “up” or open 112 position, by measuring ambient light levels. If the door 108 is determined to be open 112, the garage door position detector 700 wirelessly transmits an open door notification message 113 to a predetermined entity, such as the vehicle's owner, the garage's owner or some other person or entity, notifying one or more of them that the door is open. As with the other embodiments, the notification message 113 can be embodied as a text message, i.e., a data message or e-mail, or a pre-recorded audio message transmitted on a radio frequency signal, an audio frequency signal or light wave. The destination or address of the text message or e-mail can be specified in advance, i.e., be predetermined. If the door 108 is not timely closed, i.e., closed within a predetermined number of minutes or hours after the notification message is sent, the detector 600 can close the garage door 108 itself.

In FIG. 7, the detector 700 comprises an ambient light detector 702 attached to at least the rear window 704 or rear bumper 706 of the vehicle 104. The light detector 702 comprises a conventional photodiode, not shown, which outputs a measurable electrical signal that corresponds to the level and frequencies of light waves 708 that impinge on the photodiode when the door 108 is up or open 112. Ambient light 708 that is present at various different times of the day and which are detected by the light detector 702 can thus be used to determine whether the door 108 is in its up position 112 or down position 110.

Detecting a garage door's position using ambient light 708 is preferably accomplished by measuring and recording a first ambient light level with the garage door closed. A second ambient level is measured and recorded with the garage door open. After the open and closed light levels are measured and recorded, subsequently measured light levels are compared to the first and second levels. A subsequently-measured light level that corresponds more closely to one of the first two levels can be considered to be the ambient level caused by the door being open or closed.

The signal from the light detector 702 corresponding to a measured, ambient light lever, or a lack thereof, is sent to the processor 116. It is a signal responsive to and indicative of the position of the door 108. When the processor 116 determines whether a garage door 108 is open or closed, the processor 116 subsequently decides whether to cause the transmission of an open door notification message 113.

In yet another embodiment, the detector comprises a conventional microphone configured to detect sound levels outside the vehicle 104. Detecting the up or down location of garage door using sound can be accomplished by measuring and recording a first ambient noise level (ambient with respect to the vehicle 104 when it is inside the garage 108) with the garage door closed. A second ambient noise level is measured and recorded with the garage door open. After the two different noise levels are measured and recorded, subsequently determining whether the garage door is open or closed can be accomplished by comparing the first and second ambient noise levels to subsequently measured ambient noise levels.

When ambient noise levels are detected to be near one of the two measured and stored noise levels, the processor 116 to which the microphone is connected, determines the door 108 to be in its open position 112 or closed position 110 accordingly. Upon making such a determination, the processor 116 causes the transceiver 118 to send a door open notification message 113.

A camera, laser, laser light detector, ultrasonic sound detector, RFID detector, ambient light detector and microphone are different embodiments of sensors that generate or output measurable electrical signals responsive to corresponding physical conditions. Each of them thus able to detect a corresponding physical condition that indicates whether a garage door is open or closed.

As described above, each of the various sensors is coupled to and operates under the direction and control of a processor 116. Each of them is able to detect corresponding conditions the existence or non-existence of which will indicate whether the garage door is open or closed. Electrical signals they generate are evaluated by a processor 116, which executes program instructions that are stored in a non-volatile and non-transitory memory device.

The processor 116, which controls the sensors and evaluates their output signals, is preferably co-located with or forms part of a wireless transceiver 118 from which a message 113 can be transmitted when a sensor detects a physical condition indicative of the door 108 being open or in its up position 112. The transceiver 118 is preferably capable of transmitting on one or more cellular frequency bands as well as the frequency bands commonly used by remotely controlled garage door openers. The transceiver 118 is thus able to transmit a data message or wirelessly send an e-mail message to the address of a person or organization that might be able to close the door 108. The transceiver can also optionally transmit a second message 115 directly to a garage door opener that will cause the opener to close the door 108.

The foregoing description is for purposes of illustration only. The true scope of the invention is set forth in the following claims.

1. A garage door position detector comprising:
a location determiner, configured to determine whether a vehicle is in a garage;
a vehicle-located sensor coupled to the location determiner and configured to detect a physical condition that indicates an open position of a garage door and to generate a signal representative of the garage door being open;
a wireless transmitter coupled to the vehicle-located sensor and configured to wirelessly transmit a message indicating the position of a garage door responsive to the signal from the sensor.

2. The garage door position detector of claim 1, wherein the wireless transmitter is a radio frequency transmitter.

3. The garage door position detector of claim 2, wherein the wireless transmitter is configured to transmit a predetermined data message.

4. The garage door position detector of claim 3, wherein the predetermined data message is an open garage door alarm message transmitted to a predetermined address.

5. The garage door position detector of claim 1, wherein the vehicle-located sensor is a camera.

6. The garage door position detector of claim 1, wherein the vehicle-located sensor is an ultrasonic transducer.

7. The garage door position detector of claim 1, wherein the vehicle-located sensor is a microphone.

8. The garage door position detector of claim 1, wherein the vehicle-located sensor is configured to detect an ambient light level.

9. The garage door position detector of claim 1, wherein the vehicle-located sensor is a laser detector.

10. The garage door position detector of claim 1, wherein the vehicle-located sensor is an RFID tag.

11. The garage door position detector of claim 1, wherein the wireless transmitter is a radio frequency transmitter and configured to transmit a door close message to a garage door opener, after a predetermined time has elapsed.

12. A garage door position-sensing vehicle comprising:
a processor;
a non-transitory memory device coupled to the processor and configured to store program instructions for the processor;
a location determiner, coupled to the processor and configured to determine whether a vehicle is in a garage;
a sensor coupled to the processor and configured to generate an electrical signal representative of the garage door being open; and
a wireless transmitter coupled to the processor and configured to transmit an information-bearing message indicating the position of a garage door responsive to the signal from the sensor.

13. The garage door position-sensing vehicle of claim 12, wherein the wireless transmitter is a radio frequency transmitter.

14. The garage door position-sensing vehicle of claim 13, wherein the program instructions are configured to cause the radio frequency transmitter to transmit a garage door open warning message, responsive to the processor's receipt of a signal from sensor representative of the garage door being open.

15. A method of detecting a garage door being open, the method comprising:
detecting whether a vehicle is in a garage having a garage door;
detecting a physical condition that indicates an open position of a garage door;
generating an information-bearing signal representative of the garage door being open; and
wirelessly transmitting a message, indicating that the garage door is open, responsive to the information bearing signal received from the sensor.

16. The method of claim 15, wherein detecting a physical condition comprises:
capturing a first image of the garage door closed;
capturing a second image after the first image has been captured;
comparing the first image to the second image and determining differences between them; and
determining the garage door to be open or closed based on the result of the comparing step.

17. The method of claim 15, wherein detecting a physical condition comprises:
measuring a distance between a first end of a vehicle and an object;
determining the garage door to be open if the measured distance exceeds a predetermined threshold distance.

18. The method of claim 15, wherein detecting a physical condition comprises:
measuring and recording a first ambient light level with the garage door closed;
measuring and recording a second ambient light level with the garage door open;
subsequently determining whether the garage door is open or closed by comparing the first and second ambient light levels to subsequently measured ambient light levels.

19. The method of claim 15, wherein detecting a physical condition comprises:
measuring and recording a first ambient noise level with the garage door closed;
measuring and recording a second ambient noise level with the garage door open;
subsequently determining whether the garage door is open or closed by comparing the first and second ambient noise levels to subsequently measured ambient noise levels.

20. The method of claim 15, wherein the garage door comprises an RFID tag and wherein detecting a physical condition comprises:
measuring and recording a first RFID tag signal strength level, obtained from an RFID tag sensor when the garage door is closed;
measuring and recording a second RFID tag signal strength level, obtained from the RFID tag sensor when the garage door is open; and
subsequently determining whether the garage door is open or closed by comparing a subsequently determined RFID tag signal strength to the first and second RFID tag signal strength levels.
